(19) United States
(12) Patent Application Publication
(10) Pub. No.: US 2007/0212611 A1
(43) Pub. Date: Sep. 13, 2007

(54) Lithium secondary battery

(75) Inventors: Motoaki Nishijima, Kitakatsuragi-gun (JP); Naoto Nishimura, Kashihara-shi (JP)

Correspondence Address: NIXON & VANDERHYE, PC, 901 NORTH GLEBE ROAD, 11TH FLOOR, ARLINGTON, VA, 22203, US

(73) Assignee: Sharp Kabushiki Kaisha, Osaka (JP)

(21) Appl. No.: 11/329,421

(22) Filed: Jan. 11, 2006

(30) Foreign Application Priority Data
Jan. 17, 2005 (JP) 2005-009152

(51) Int. Cl. H01M 4/62; H01M 4/66; H01M 4/80

(52) U.S. Cl. 429/232; 429/245; 429/235

(57) ABSTRACT

A lithium secondary battery comprising a battery element composed of a positive electrode, a negative electrode and a separator providing electrical isolation between the positive electrode and the negative electrode, the positive electrode or negative electrode having a positive active material or a negative active material, a conductive material and a current collector, and the conductive material having a first conductive material containing at least one species of a carbon material and a second conductive material bonding the positive active material or the negative active material, the first conductive material and the current collector to one another.

### TECHNICAL FIELD

The present invention relates to a lithium secondary battery. More specifically, the present invention relates to a large capacity lithium secondary battery which is suitably used for a nonaqueous electrolyte secondary battery for power storage and has excellent cycle characteristics and load characteristics.

### BACKGROUND ART

A secondary battery is often used as a power supply for portable equipment from the viewpoint of cost effectiveness. Various kinds of secondary batteries are available, and a nickel-cadmium battery is most popular at present. Recently, a nickel-hydrogen battery becomes widespread. Further, there is reported a lithium secondary battery using lithium cobalt oxide (LiCoO₂), lithium nickel oxide (LiNiO₂), a solid solution (Li(Co₁₋ₓNiₓ)O₂) thereof or lithium manganese oxide (LiMn₂O₄) having a spinel type structure as a positive active material, and a carbon material like graphite as a negative active material, and an electrolyte in which a liquid organic compound is a solvent and a lithium compound is a solute. Since a lithium secondary battery has a higher output voltage than that of a nickel-cadmium battery or a nickel-hydrogen battery and, also, has a high energy density, it is becoming main among the secondary batteries.

Batteries having a capacity of the order of 1 Ah generally used in portable equipment are constructed as follows.

The battery has a structure in which a rolled-up body or a laminate, prepared by rolling up or laminating a constitution in which a positive electrode having a thickness of about one hundred and several tens of microns and a negative electrode having a thickness of about one hundred and several tens of microns are placed on opposite sides of a porous insulating separator, is encapsulated together with an electrolyte in a metal film or a resin film or having a metal layer.

It is known that the lithium secondary battery has high energy efficiency (discharge power/charged power) in addition to having a high output voltage and a high energy density as described above and these properties are suitable as a device for power storage, but it has two major problems.

The first problem concerns cycle life. The life of the lithium secondary battery currently used in portable equipment is of the order of several hundreds of cycles. However, in order to store at least several years' power, a life of several thousands of cycles is required even if a charge-discharge operation is carried out once a day. In the lithium secondary battery, a binder consisting of a resin like polyvinylidene fluoride is generally used for a positive electrode and/or a negative electrode. In charging the lithium secondary battery, there occurs a reaction of desorbing a lithium ion from a positive active material and inserting this ion into carbon of the negative electrode. At this time, the active material of the positive electrode and the negative electrode expands or contracts. Therefore, the expansion and contraction of the active material itself is repeated with the passage of a charge-discharge cycle, and the active material is physically dropped out from a current collector or a conductive auxiliary material little by little. As a result, an inert portion increases and consequently this causes a problem of reducing a battery capacity.

The second problem concerns an increase in capacity. It is necessary to store power of from several kilowatt-hours to several tens of kilowatt-hours for power storage. Therefore, in batteries having a capacity of the order of 1 Ah currently used in portable equipment, it is necessary to connect several tens of batteries in parallel and connect one hundred and several tens of groups of these batteries connected in parallel in series. In order to reduce such complicated connections, the battery for power storage requires increasing the battery capacity to 5 Ah or more.

As an approach of increasing the battery capacity, an attempt to increase the capacity of the conventional small battery is made as shown, for example, in reports (Development of New Battery Power Storage System, and Development of Distributed Power Storage Technology) of a consignment study in 2001. However, in the above-mentioned conventional production method of a battery, it is necessary to wind up or laminate an electrode obtained by making metal foil support an active material. As a result, in a large-capacity battery, since a capacity is large compared with a small battery, that is, an area of an electrode is large, a production process becomes more complicated than the small battery and a production cost becomes high.

As a solution to this, there is thought a method of thickening the electrode of the battery. However, if the electrode is thickened, the distance between the current collector and the active material becomes longer and the electric resistance within the electrode increases. Consequently, there is a problem that the internal resistance of the battery increases and the energy loss in charging and discharging becomes large.

### SUMMARY OF THE INVENTION

Thus, according to the present invention, there is provided a lithium secondary battery comprising a battery element composed of a positive electrode, a negative electrode and a separator providing electrical isolation between the positive electrode and the negative electrode, the positive electrode or negative electrode having a positive active material or a negative active material, a conductive material and a current collector, and the conductive material having a first conductive material containing at least one species of a carbon material and a second conductive material bonding the positive active material or the negative active material, the first conductive material and the current collector to one another.

### BRIEF DESCRIPTION OF THE DRAWINGS

FIG. 1 is a schematic view illustrating a manner in which an active material, a conductive material and a current collector in a conventional electrode are fixed by a binder; and

FIG. 2 is a schematic view illustrating a manner in which an active material, a first conductive material and a current collector in an electrode are fixed by a second conductive material of the present invention.

### BEST MODE FOR CARRYING OUT THE INVENTION

First, in the present invention, the term “bonding” refers to a state in which two faces are coupled to each other by a chemical or physical force or both thereof through the medium of a binder comprising of a second conductive material. Bonding is made up of mechanical coupling (bonding), bonding by physical interaction and bonding by chemical interaction. The mechanical coupling refers to coupling resulting from the solidification of a liquid binder which has penetrated into a pore or a gap in the surface of a material. The bonding by physical interaction is referred to as an intermolecular attractive force and refers to coupling resulting from the attractive forces between molecules (Van der Waals force). The bonding by chemical interaction is coupling by a covalent bond or a hydrogen bond.

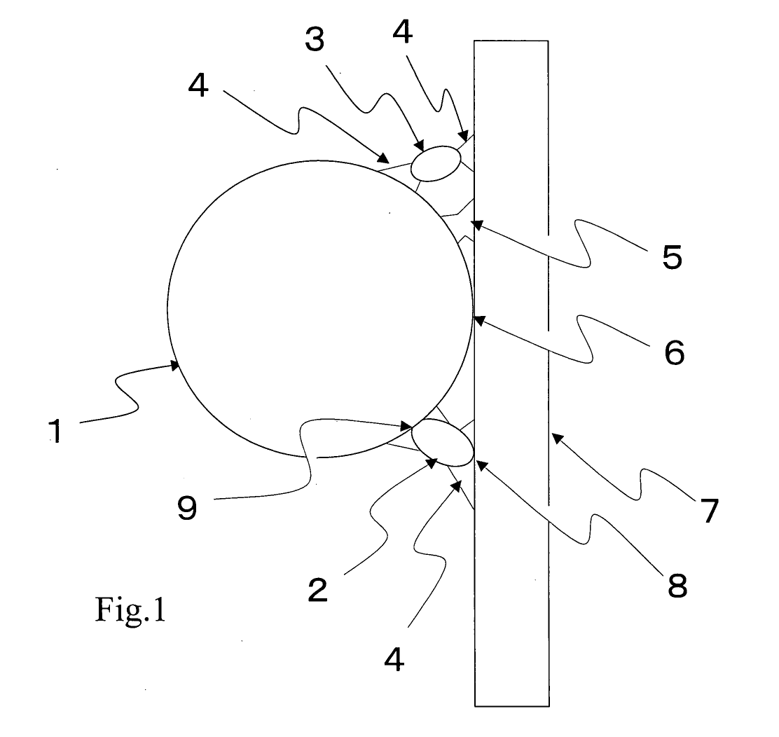

Here, according to the conventional art, an active material is bonded to a conductive material in an electrode by a binder. This bonding manner is shown in FIG. 1. The active material is bonded to a current collector by a binder 5. Conductive materials 2 and 3 are bonded to a current collector 7 and an electrode active material 1 by a binder 4. In this figure, the conductive material 3 does not contact the current collector 7 and the electrode active material 1, and electrons from the active material 1 flow into the current collector through a contact 6 of the current collector and the active material, a contact 8 of the conductive material and the current collector and a contact 9 of the conductive material and the active material. The binder has a certain degree of flexibility since resin is used as a binder material. Therefore, the respective contacts, that is, the contact 6 of the active material, the contact 8 of the conductive material and the current collector and the contact 9 of the conductive material and the active material are readily separated through the expansion/contraction of the active material due to charge and discharge. Consequently, electrons do not flow through the active material 1 and the active material loses an action as an active material.

On the other hand, in the present invention, a second conductive material is used as a binder and an electrode active material, a first conductive material and a current collector can be bonded to one another while maintaining the conductivity through the medium of this second conductive material.

Hereinafter, specific embodiments will be described. In addition, when referring to just an electrode, it includes a positive electrode and/or a negative electrode, and when referring to just an active material, it includes a positive active material and/or a negative active material.

According to the present invention, the positive electrode or the negative electrode has the following constitution.

As the positive active material, there can be used lithium transition metal complex oxide, lithium transition metal complex sulfide, lithium transition metal complex nitride, a lithium transition metal phosphate compound, and the like. Among them, a material which is hard to change in a composition or a structure by heat treatment in a reducing atmosphere is preferred, and specifically a lithium transition metal phosphate complex compound: LiMPO₄ (here, M is at least one of Fe, Mn, Co, and Ni) is preferred. The electron conductivity of these lithium transition metal phosphate complex compounds may be enhanced by being coated with a conductive material.

As the negative active material, a material, into/from which lithium can be electrochemically inserted/desorbed, is preferred. In order to constitute a high energy density battery, a material, in which a potential at which lithium is inserted into/desorbed from the material is close to the deposition potential/dissolution potential of metal lithium, is preferably used. This typical example is carbon materials such as natural or artificial graphite in the form of particle (scale, lump, fiber, whisker, sphere, ground particle or the like). Artificial graphite includes graphite obtained by graphitizing meso carbon micro bead, mesophase pitch powder, isotropic pitch powder and the like. Also, a graphite particle, the surface of which amorphous carbon adheres to, can be used. Alternatively, lithium transition metal oxide, lithium transition metal nitride, transition metal oxide, silicon oxide and the like can be used. Among these materials, a material which is hard to change in a composition or a structure by heat treatment in a reducing atmosphere is preferred, and specifically carbon material is preferred.

Next, as the first conductive material, a material having electron conductivity is preferred and chemically stable materials such as carbon black, acetylene black, Ketjen Black, carbon fiber and conductive metal oxides are given. These materials may be used singly or in combination of two or more species.

Next, as the second conductive material, carbide prepared by carbonizing an organic compound (a precursor of the second conductive material) by heat treatment is suitably used.

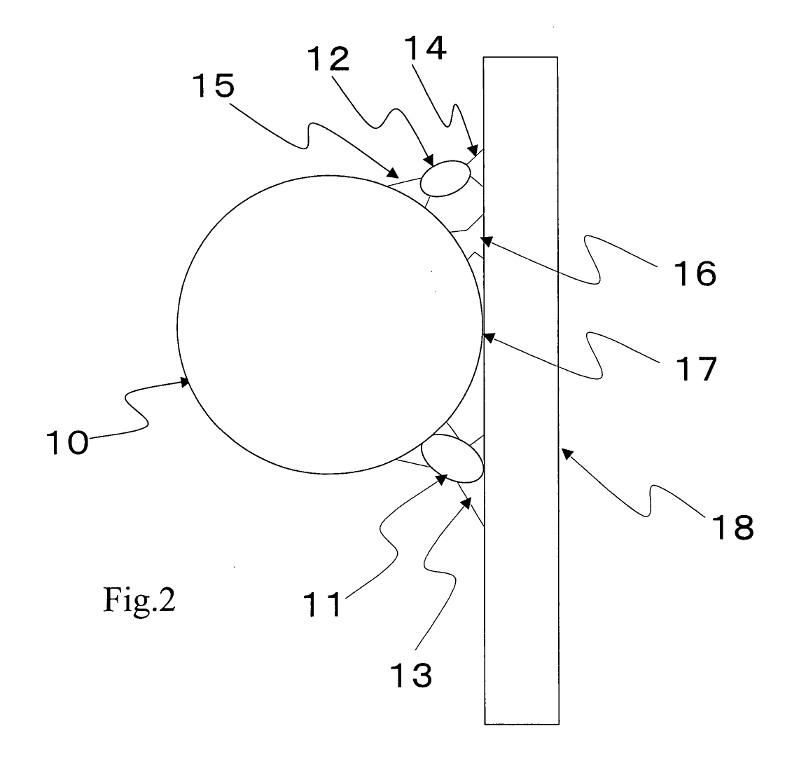

By heat-treating the precursor, the precursors 4 and 5 in FIG. 1 are carbonized and converted to the second conductive material. This manner is shown in FIG. 2. Herein, the term “precursor” represents a material at a pre-stage for obtaining a second conductive material and particularly the precursor in the present specification refers to a material having a carbon skeleton in its material. Carbonated precursors (second conductive materials) 14, 15 and 16 are stronger and less flexible than resin. Accordingly, the active material, the first conductive material and the current collector can be bonded firmly to one another, and therefore the respective contacts between the active material, the first conductive material and the current collector are not separated. As a result, a lithium secondary battery having excellent cycle characteristics can be provided.

In addition, since the carbonated precursors 14 and 15 have conductivity, the first conductive material 12 not directly contacting the active material comes to act as a conductive path via the carbonated precursors. Further, since the carbonated precursor between the active material and the current collector also has conductivity, it acts as an electron conductive path between the active material and the current collector. Therefore, it is possible to provide a lithium secondary battery in which load characteristics are not deteriorated even if a thickness of an electrode is increased.

The above-mentioned precursor includes: thermosetting resins such as phenolic resin, polyester resin, epoxy resin, urea resin, and melamine resin; thermoplastic resins such as polyethylene resin, polypropylene resin, polyvinyl chloride resin, polyvinyl acetate resin, polyvinyl pyrrolidone, acrylic resin, styrol resin, polycarbonate resin, nylon resin, polymers and copolymers derived from acrylonitrile, methacrylonitrile, vinyl fluoride, chloroprene, vinylpyridine and derivatives thereof, vinylidene chloride, ethylene, propylene, celluloses, cyclic diene (for example, cyclopentadiene, 1,3-cyclohexadiene, or the like), styrene-butadiene rubber, and the like; carbohydrates such as saccharides, starch and paraffin; tar; pitch; and coke.

Of the above-mentioned precursors, the thermoplastic resin develops fluidity by being heat-treated. Therefore, the thermoplastic resin adheres to the surfaces of the active material and the first conductive material better by being heat-treated and is carbonized in this state. Thus, when the thermoplastic resin is used, a strong bonding effect can be expected. In addition, the thermosetting resin can be carbonized without changing in a shape by being heat-treated. Therefore, it has an advantage that a change in a shape before and after heat treatment is little. Since carbohydrate generally consists of only carbon, hydrogen and oxygen, it has an advantage that it is hard to emit hazardous substances through heat treatment. Since tar, pitch and coke inherently have high carbon contents, they have an advantage that the contraction of a volume due to heat treatment is little. The precursor may be used singly or in combination of two or more in consideration of the above-mentioned characteristics.

Since the above-mentioned precursor is carbonized by heat treatment and used as a second conductive material, components of the precursor are volatilized through thermal decomposition in heat treatment. Therefore, a precursor which is hard to emit hazardous substances through thermal decomposition is preferred, and specifically precursors composed of only carbon, hydrogen and oxygen such as polyvinyl acetate, polyacetylene, sugar, starch and the like and precursors having a high carbon content such as tar, pitch, coke and the like are preferred.

Further, as a precursor used on a positive electrode side, substances which are carbonized at a temperature of 650° C. or less are preferred. Specifically, there are given polyvinyl pyrolidone, carboxymethylcellulose, vinyl acetate, sugar and the like. As a precursor used on a negative electrode side, substances which are carbonized at a temperature of 1000° C. or less are preferred. Specifically, there are given carboxymethylcellulose, pitch and the like.

A carbon content of the carbonated precursor is preferably 1 to 30% by weight with respect to the amount of the active material. When the carbon content is less than 1% by weight with respect to the amount of the active material, it is not preferred since an adhesive force between the active material, the first conductive material and the current collector may become too weak to deteriorate the cycle characteristics. When the carbon content is more than 30% by weight with respect to the amount of the active material, it is not preferred since the volume which the carbonated precursor make up in the electrode becomes large and the energy density of the battery is reduced.

The positive electrode and the negative electrode can be constructed as follows. That is, the predetermined amounts of the active material, the first conductive material and the precursor of the current collector are weighed out to form a mixture by mixing, and the mixture is carried on the current collector. A method of mixing is not particularly limited. A method of making the current collector carry the mixture includes, for example, a method of making the current collector carry a powder mixture directly, and a method of making the current collector carry a mixture converted to paste by adding a solvent to a mixture.

The solvent for converting to paste is not particularly limited but a solvent which can dissolve the precursor is preferred. As the solvent, there are given organic solvents such as N-methyl pyrrolidone, acetone and alcohols, and water. Among them, water is preferred because of a low price and a small environmental burden. Incidentally, when the precursor is liquid at room temperature, it has plasticity by applying heat and it becomes liquid by applying heat, the solvent have not to be used.

The mixture converted to paste may be applied directly onto the current collector, or it may be processed into an arbitrary shape in advance and then transferred to the current collector.

When the solvent is added to a mixture, it is preferred to dry a carried mixture in order to remove the solvent after the current collector carries the mixture converted to paste. Drying may be carried out in air or under a reduced pressure. Further, it is preferred to dry at a temperature of about 80° C. in order to shorten a drying time period. When a solvent is not used for the mixture, a drying process is unnecessary.

The current collector includes a foamed (porous) metal having a continuous pore, a metal shaped like a honeycomb, a nonwoven fabric, a plate, foil, and a perforated plate and foil of sintered metal, and the like. As a current collector, which can be used for a positive electrode, there are preferably used aluminum and alloys containing aluminum. As a current collector which can be used for a negative electrode, there are preferably used copper, alloys containing copper, nickel and alloys containing nickel.

Here, a film of a pre-heat treatment mixture may be pressed in order to increase the density of an electrode. The reason for this is that since the precursor is carbonized and loses the flexibility by heat treatment, pressing after heat treatment may causes binding forces between the active material, the first conductive material and the current collector to deteriorate.

Next, by heat-treating a film of a mixture in an electric furnace and the like, the precursor is carbonized. A temperature of heat-treating is preferably below a melting point of the current collector. For example, when the current collector is aluminum, since a melting point of aluminum is 660° C., the temperature of heat-treating is preferably up to 650° C. which is a temperature below the melting point of aluminum. When the current collector is copper or nickel, since melting points of theses metals are about 1000° C., the temperature of heat-treating is preferably up to 1000° C. The temperature of heat-treating is preferably 250° C. or more. When this temperature is less than 250° C., it is not preferred because the carbonization of the precursor does not adequately proceed. Incidentally, a time of heat-treating is not particularly limited.

As for an atmosphere for heat-treating, if oxygen is contained in the atmosphere, the precursor or the conductive material may burn. Therefore, the atmosphere for heat-treating is preferably an inert atmosphere which does not contain oxygen substantially. Here, the term “does not contain oxygen substantially” means specifically that oxygen is 0.1% or less in a volume fraction. As the inert atmosphere, there are given atmospheres of nitrogen, argon and neon. Of these atmospheres, the atmosphere of nitrogen is preferred from the viewpoint of economy.

A thickness of an electrode is preferably 0.2 to 10 mm. When this thickness is less than 0.2 mm, it is not preferred since number of laminated electrodes needs to be increased in order to construct a large-capacity battery. On the other hand, when it is more than 10 mm, it is not preferred since the internal resistance of the electrode increases and load characteristics of the battery are deteriorated.

The above-mentioned second conductive material may be included in either one of the positive electrode or the negative electrode. In this case, an electrode prepared by a publicly known method can be employed for the other electrode. Particularly in the present invention, both of the positive electrode and the negative electrode preferably include the second conductive material.

Next, a battery is assembled using the positive electrode and the negative electrode. This manufacturing process is, for example, as follows.

The positive electrode and the negative electrode are laminated interposing a separator between these electrodes. The laminated electrode may have, for example, a strap-shaped plane configuration. In addition, when a cylindrical battery or a flat battery is prepared, the laminated electrode may be wound up.

The separator includes a porous material or a nonwoven fabric. A material of the separator is preferably a substance which is not dissolved in or swelled by an organic solvent contained in an electrolyte and includes, specifically, polyester polymers, polyolefin polymers (for example, polyethylene, polypropylene), ether polymers and inorganic materials like glass.

One or more laminated electrodes are inserted into a battery container and the positive electrode and the negative electrode are connected to the external conductive terminals of the battery. Then, the battery container is hermetically sealed in order to cut off the electrode and the separator from the outside air. As a method of hermetically sealing, a method, in which a cap with a resin gasket is fit in an opening of the battery container and the container is crimped, is common for a cylindrical battery. In addition, for a prismatic battery, there can be employed a method of attaching a metallic cap, referred to as a sealing cap, to an opening and welding it. Other than these methods, a method of hermetically sealing with a binder and a method of securing a gasket with a bolt can also be used. Further, a method of hermetically sealing with a laminated film formed by pasting a thermoplastic resin to metal foil can also be used. Herein, an opening for pouring an electrolyte may be provided in sealing.

Next, the electrolyte is poured into the laminated electrode. As the electrolyte, for example, an organic electrolyte, an electrolyte in gel form, a solid polyelectrolyte, an inorganic solid electrolyte and melted salt can be used. The opening of the battery is sealed after pouring the electrolyte. A generated gas may be eliminated by the passage of electric current prior to sealing.

### EXAMPLES

Hereinafter, the present invention will be described more specifically by way of examples.

### Example 1

Electrodes were prepared in accordance with the following procedure.

LiFePO₄ was used for a positive active material, acetylene black was used for a first conductive material and polyvinyl acetate was used for a precursor of a second conductive material as a binder, and these compounds were mixed in weight proportions of 100:10:15. 50 ml of water was added to this mixture, and the resulting mixture was kneaded using a kneading apparatus to obtain a paste. The paste was applied onto an aluminum plate of 100 μm in thickness having a size of 20 cm×30 cm so as to be 0.5 mm in thickness. In addition, aluminum current terminal 5 mm wide and 100 μm thick had been previously welded to the aluminum plate. The aluminum plate coated with paste was left standing for 12 hours in a drier of 60° C. to remove water being a solvent. After this, a thickness of a coated layer was adjusted to 0.3 mm by pressing at a pressure of 300 kg/cm².

Then, the aluminum plate with the coated layer was heat-treated at 600° C. in an atmosphere of nitrogen. Specifically, a temperature of the aluminum plate was raised at a rate of 5° C./min from room temperature to 600° C. and retained at 600° C. for 6 hours after reaching 600° C. After this retention, the aluminum plate was left standing until it reached room temperature and taken out. A positive electrode was obtained by this heat treatment.

Natural graphite was used for a negative active material, acetylene black was used for a first conductive material and polyvinyl acetate was used for a precursor of a second conductive material as a binder, and these compounds were mixed in weight proportions of 100:5:10. 50 ml of water was added to this mixture, and the resulting mixture was kneaded using a kneading apparatus to obtain a paste. The paste was applied onto a copper plate of 100 μm in thickness having a size of 20 cm×30 cm so as to be 0.5 mm in thickness. In addition, a copper current terminal 5 mm wide and 100 μm thick had been previously welded to the copper plate. The copper plate coated with paste was left standing for 12 hours in a drier of 60° C. to remove water being a solvent. After this, a thickness of a coated layer was adjusted to 0.3 mm by pressing at a pressure of 300 kg/cm².

Then, the copper plate with the coated layer was heat-treated at 1000° C. in an atmosphere of nitrogen. Specifically, a temperature of the copper plate was raised at a rate of 5° C./min from room temperature to 1000° C. and retained at 1000° C. for 6 hours after reaching 1000° C. After this retention, the copper plate was left standing until it reached room temperature and taken out. A negative electrode was obtained by this heat treatment.

A battery was prepared in accordance with the following procedure using the above-mentioned positive electrode and negative electrode, and load characteristics and cycle characteristics were evaluated on this battery.

First, the positive electrode and the negative electrode were dried under a reduced pressure at 150° C. for 12 hours in order to remove water. In addition, all of the following works were carried out in a dry box in an argon atmosphere where a dew point is −80° C. or less.

Next, a positive electrode and a negative electrode were laminated interposing a separator 50 μm thick, made of porous polyethylene, between these electrodes. The resulting laminate was inserted into a bag formed from a laminate film formed by welding a low-melting point polyethylene film of 50 μm in thickness to aluminum foil of 50 μm in thickness. An electrolyte was poured into the bag and an opening of the bag was sealed by thermally welding to complete a battery. Further, as the electrolyte, there was used a solution formed by dissolving LiPF₆ in a solution consisting of ethylene carbonate and diethyl carbonate of a weight ratio of 1:1 so as to be 1.0 mol/l.

The completed battery was charged at a constant current of 1 A until the voltage of the battery reached 4.0 V, and from then on the battery was charged at a constant voltage of 4.0 V for 2 hours to complete charging. Then, the battery was discharged at a current of 1 A until the voltage of the battery reached 2.5 V. A discharged capacity during this discharge was taken as a rated capacity of this battery.

Next, after completing charging under the same conditions as the above-described procedure, discharging was performed at 10 hours rate, 5 hours rate and 3 hours rate and load characteristics were measured. Herein, the terms 10 hours rate, 5 hours rate and 3 hours rate refer to current values at which all capacity of the rated capacity of the battery is discharged in 10 hours, 5 hours and 3 hours, respectively.

In addition, the battery was charged at a constant current of a 5 hours rate until the voltage of the battery reached 4.0 V, and from then on the battery was charged at a constant voltage of 4.0 V for 2 hours to complete charging and then it was discharged at a 5 hours rate, and this charge-discharge cycle was repeated 100 times. By comparing the discharged capacity obtained at a 100th cycle with an initial discharged capacity, cycle characteristics were evaluated.

### Example 2

Electrodes were prepared in accordance with the following procedure.

LiFePO₄ was used for a positive active material, acetylene black was used for a first conductive material and sugar (saccharose) was used for a precursor of a second conductive material as a binder, and these compounds were mixed in weight proportions of 100:10:15. 50 ml of water was added to this mixture, and the resulting mixture was kneaded using a kneading apparatus to obtain a paste. The paste was filled into a foamed aluminum of 1.5 mm in thickness having a size of 20 cm×30 cm, which has continuous pore. In addition, aluminum current terminal 5 mm wide and 100 μm thick had been previously welded to the foamed aluminum. The foamed aluminum filled with paste was left standing for 12 hours in a drier of 60° C. to remove water being a solvent. After this, a thickness of the foamed aluminum was adjusted to 1 mm by pressing at a pressure of 300 kg/cm².

Then, the foamed aluminum plate filled with paste was heat-treated at 300° C. in an atmosphere of nitrogen. Specifically, a temperature of the foamed aluminum was raised at a rate of 5° C./min from room temperature to 300° C. and retained at 300° C. for 6 hours after reaching 300° C. After this retention, the foamed aluminum was left standing until it reached room temperature and taken out. A positive electrode was obtained by this heat treatment.

Natural graphite was used for a negative active material, acetylene black was used for a first conductive material and sugar (saccharose) was used for a precursor of a second conductive material as a binder, and these compounds were mixed in weight proportions of 100:5:10. 50 ml of water was added to this mixture, and the resulting mixture was kneaded using a kneading apparatus to obtain a paste. The paste was filled into a foamed nickel of 1.5 mm in thickness having a size of 20 cm×30 cm, which has continuous pore. In addition, a copper current terminal 5 mm wide and 100 μm thick had been previously welded to the foamed nickel. The foamed nickel filled with paste was left standing for 12 hours in a drier of 60° C. to remove water being a solvent. After this, a thickness of the foamed nickel was adjusted to 1.0 mm by pressing at a pressure of 300 kg/cm².

Then, the foamed nickel filled with paste was heat-treated at 300° C. in an atmosphere of nitrogen. Specifically, a temperature of the foamed nickel was raised at a rate of 5° C./min from room temperature to 300° C. and retained at 300° C. for 6 hours after reaching 300° C. After this retention, the foamed nickel was left standing until it reached room temperature and taken out. A negative electrode was obtained by this heat treatment.

A battery was prepared in accordance with the same procedure as in Example 1 except for using the above-mentioned positive electrode and negative electrode, and load characteristics and cycle characteristics were evaluated on this battery.

### Example 3

Electrodes were prepared in accordance with the following procedure.

LiFePO₄ was used for a positive active material, acetylene black was used for a first conductive material and polyvinyl pyrolidone was used for a precursor of a second conductive material as a binder, and these compounds were mixed in weight proportions of 100:10:15. 20 ml of water was added to this mixture, and the resulting mixture was kneaded using a kneading apparatus to obtain a paste. The paste was filled into an aluminum plate of 6 mm in thickness having a size of 10 cm×10 cm, which has 4 mm-bore openings in the form of a honeycomb. In addition, aluminum current terminal 5 mm wide and 100 μm thick had been previously welded to the aluminum plate. The aluminum plate filled with paste was left standing for 12 hours in a drier of 60° C. to remove water being a solvent.

Then, the aluminum plate filled with paste was heat-treated at 600° C. in an atmosphere of nitrogen. Specifically, a temperature of the aluminum plate was raised at a rate of 5° C./min from room temperature to 600° C. and retained at 600° C. for 6 hours after reaching 600° C. After this retention, the aluminum plate was left standing until it reached room temperature and taken out. A positive electrode was obtained by this heat treatment.

Natural graphite was used for a negative active material, acetylene black was used for a first conductive material and tar was used for a precursor of a second conductive material as a binder, and these compounds were mixed in weight proportions of 100:5:10. 20 ml of water was added to this mixture, and the resulting mixture was kneaded using a kneading apparatus to obtain a paste. The paste was filled into a copper plate of 6 mm in thickness having a size of 10 cm×10 cm, which has 4 mm-bore openings in the form of a honeycomb. In addition, a copper current terminal 5 mm wide and 100 μm thick had been previously welded to the copper plate. The foamed nickel filled with paste was left standing for 12 hours in a drier of 60° C. to remove water being a solvent.

Then, the copper plate filled with paste was heat-treated at 1000° C. in an atmosphere of nitrogen. Specifically, a temperature of the copper plate was raised at a rate of 5° C./min from room temperature to 1000° C. and retained at 1000° C. for 6 hours after reaching 1000° C. After this retention, the copper plate was left standing until it reached room temperature and taken out. A negative electrode was obtained by this heat treatment.

A battery was prepared in accordance with the same procedure as in Example 1 except for using the above-mentioned positive electrode and negative electrode, and load characteristics and cycle characteristics were evaluated on this battery.

### Example 4

Electrodes were prepared in accordance with the following procedure.

LiFePO₄ was used for a positive active material, acetylene black was used for a first conductive material and carboxymethylcellulose was used for a precursor of a second conductive material as a binder, and these compounds were mixed in weight proportions of 100:10:15. 50 ml of water was added to this mixture, and the resulting mixture was kneaded using a kneading apparatus to obtain a paste. The paste was filled into a metallic nonwoven fabric of 12 mm in thickness having a size of 10 cm×10 cm, which is formed by sintering 100 μm-diameter aluminum fibers. In addition, aluminum current terminal 5 mm wide and 100 μm thick had been previously welded to the metallic nonwoven fabric. The aluminum plate filled with paste was left standing for 12 hours in a drier of 60° C. to remove water being a solvent. After this, a thickness of the metallic nonwoven fabric was adjusted to 10 mm by pressing at a pressure of 300 kg/cm².

Then, the metallic nonwoven fabric filled with paste was heat-treated at 600° C. in an atmosphere of nitrogen. Specifically, a temperature of the metallic nonwoven fabric was raised at a rate of 5° C./min from room temperature to 600° C. and retained at 600° C. for 6 hours after reaching 600° C. After this retention, the metallic nonwoven fabric was left standing until it reached room temperature and taken out. A positive electrode was obtained by this heat treatment.

Natural graphite was used for a negative active material, acetylene black was used for a first conductive material and pitch was used for a precursor of a second conductive material as a binder, and these compounds were mixed in weight proportions of 100:5:10. 50 ml of water was added to this mixture, and the resulting mixture was kneaded using a kneading apparatus to obtain a paste. The paste was filled into a metallic nonwoven fabric of 12 mm in thickness having a size of 10 cm×10 cm, which is formed by sintering 100 μm-diameter copper fibers. In addition, a copper current terminal 5 mm wide and 100 μm thick had been previously welded to the metallic nonwoven fabric. The metallic nonwoven fabric filled with paste was left standing for 12 hours in a drier of 60° C. to remove water being a solvent. After this, a thickness of the metallic nonwoven fabric was adjusted to 10 mm by pressing at a pressure of 300 kg/cm².

Then, the metallic nonwoven fabric filled with paste was heat-treated at 1000° C. in an atmosphere of nitrogen. Specifically, a temperature of the metallic nonwoven fabric was raised at a rate of 5° C./min from room temperature to 1000° C. and retained at 1000° C. for 6 hours after reaching 1000° C. After this retention, the metallic nonwoven fabric was left standing until it reached room temperature and taken out. A negative electrode was obtained by this heat treatment.

A battery was prepared in accordance with the same procedure as in Example 1 except for using the above-mentioned positive electrode and negative electrode, and load characteristics and cycle characteristics were evaluated on this battery.

### Comparative Example 1

A battery was prepared in accordance with the same procedure as in Example 1 except for not performing heat treatment at 600° C. and 1000° C., and load characteristics and cycle characteristics were evaluated on this battery.

### Comparative Example 2

A positive electrode was prepared in accordance with the same procedure as in Example 1 except for changing a temperature of heat treatment for forming the positive electrode to 700° C. In this case, an aluminum material of a current collector was melted and a configuration of the positive electrode could not be maintained to fail to prepare a battery.

### Comparative Example 3

A negative electrode was prepared in accordance with the same procedure as in Example 1 except for changing a temperature of heat treatment for forming the negative electrode to 1100° C. In this case, an aluminum material of a current collector was melted and a configuration of the negative electrode could not be maintained to fail to prepare a battery.

### Comparative Example 4

A battery was prepared in accordance with the same procedure as in Example 1 except for changing a temperature of heat treatment for forming the positive electrode to 250° C., and load characteristics and cycle characteristics were evaluated on this battery.

### Comparative Example 5

A battery was prepared in accordance with the same procedure as in Example 1 except for changing a temperature of heat treatment for forming the negative electrode to 250° C., and load characteristics and cycle characteristics were evaluated on this battery.

### Comparative Example 6

A positive electrode was prepared in accordance with the same procedure as in Example 1 except for changing an atmosphere at the time of heat-treating for forming the positive electrode from nitrogen to air. In this case, since a first conductive material and a precursor of a second conductive material were oxidized by air and burnt, a positive active material was dropped out from a current collector, and therefore a positive electrode having adequate performance could not be obtained and a battery could not be prepared.

### Comparative Example 7

A negative electrode was prepared in accordance with the same procedure as in Example 1 except for changing an atmosphere at the time of heat-treating for forming the negative electrode from nitrogen to air. In this case, since a first conductive material and a precursor of a second conductive material were oxidized by air and burnt, a negative active material was dropped out from a current collector, and therefore a negative electrode having adequate performance could not be obtained and a battery could not be prepared.

The load characteristics and cycle characteristics of the batteries of Examples 1 to 4 and Comparative Examples 1 to 7 are summarized in Table 1.

TABLE 1

| | Discharged | | | Ratio to | | | |
|---|---|---|---|---|---|---|---|
| | capacity (Ah) | | | 10 hours rate (%) | | Capacity | Retention |
| | 10 hours | 5 hours | 3 hours | 5 hours | 3 hours | at 100th | at 100th |
| | rate | rate | rate | rate | rate | cycle (Ah) | cycle (%) |
| Ex. 1 | 5.13 | 4.9 | 4.7 | 95.3 | 92.1 | 4.99 | 97.2 |
| Ex. 2 | 17.1 | 16.1 | 15.4 | 94.2 | 90.1 | 16.9 | 98.6 |
| Ex. 3 | 14.2 | 13.1 | 12.6 | 92.1 | 88.9 | 13.8 | 97.4 |
| Ex. 4 | 28.5 | 25.9 | 24.8 | 91.0 | 87.0 | 27.3 | 95.9 |
| Com. Ex. 1 | 5.09 | 4.3 | 3.1 | 85.3 | 60.2 | 3.2 | 62.3 |
| Com. Ex. 2 | — | — | — | — | — | — | — |
| Com. Ex. 3 | — | — | — | — | — | — | — |
| Com. Ex. 4 | 5.09 | 4.1 | 2.6 | 80.1 | 50.6 | 2.55 | 50.1 |
| Com. Ex. 5 | 5.10 | 3.8 | 1.6 | 75.3 | 32.2 | 1.29 | 25.3 |
| Com. Ex. 6 | — | — | — | — | — | — | — |
| Com. Ex. 7 | — | — | — | — | — | — | — |

It is found from Table 1 that any batteries in Examples 1 to 4 exhibit good load characteristics compared with that in Comparative Examples 1 to 7 and have good cycle characteristics.

According to the present invention, it is possible to provide a battery, which can prevent peeling of the active material from the first conductive material, which is attendant on a lapse of cycle, and can withstand a long cycle since the active material and the first conductive material can be bonded firmly to each other through the second conductive material. Further, according to the present invention, it is possible to reduce electric resistance between the first conductive material and the active material because the second conductive material exerts the conductivity more than the conventional binder. Accordingly, it is possible to provide a large-capacity battery in which the load characteristics of the battery are improved and an electrode has a larger thickness than the conventional battery.

What is claimed is:

1. A lithium secondary battery comprising a battery element composed of a positive electrode, a negative electrode and a separator providing electrical isolation between the positive electrode and the negative electrode, the positive electrode or negative electrode having a positive active material or a negative active material, a conductive material and a current collector, and the conductive material having a first conductive material containing at least one species of a carbon material and a second conductive material bonding the positive active material or the negative active material, the first conductive material and the current collector to one another.

2. The lithium secondary battery according to claim 1, wherein the second conductive material is a material prepared by carbonizing a precursor of the second conductive material by a heat treatment.

3. The lithium secondary battery according to claim 1, wherein the precursor is heat-treated, after mixture of the positive active material or the negative active material, the first conductive material and the precursor of the second conductive material is carried on the current collector.

4. The lithium secondary battery according to claim 1, wherein the current collector of the positive electrode is a porous aluminum having a continuous pore, aluminum shaped like a honeycomb, a nonwoven fabric of sintered aluminum fiber or aluminum plate.

5. The lithium secondary battery according to claim 1, wherein the current collector of the negative electrode is, a porous nickel having a continuous pore, nickel shaped like a honeycomb, a nonwoven fabric of sintered nickel fiber, nickel plate, a porous copper having a continuous pore, copper shaped like a honeycomb, a nonwoven fabric of sintered copper fiber or copper plate.
